(19) United States
(12) Patent Application Publication
(10) Pub. No.: US 2005/0205400 A1
(43) Pub. Date: Sep. 22, 2005

(54) Silver contact structure for conductive blades

(76) Inventor: Chin-Wen Chou, Taipei Hsien (TW)

Correspondence Address: BIRCH STEWART KOLASCH & BIRCH, PO BOX 747, FALLS CHURCH, VA, 22040-0747, US

(21) Appl. No.: 10/802,749

(22) Filed: Mar. 18, 2004

(51) Int. Cl. H01H 1/02

(52) U.S. Cl. 200/267

(57) ABSTRACT

A silver contact structure for conductive blades aims at providing an increased contact area between a silver contact and a conductive blade so that the silver contact may be fixed more securely without breaking off. The conductive blade has a fastening section running through which has a non-circular and irregular cross section to increase the horizontal frictional force so that the silver contact is less likely to break off and may result in a longer service life. The contact area between the silver contact and the conductive blade also increases, thus enhancing the heat dissipation.

### FIELD OF THE INVENTION

The present invention relates to a silver contact structure for conductive blades and particularly to a technique that employs a novel conductive blade structure to increase the strength of silver contacts and heat dissipation.

### BACKGROUND OF THE INVENTION

Conventional techniques for fabricating silver contacts often encounter some problems, notably:

Silver contacts are usually used in switches to establish conductive connections. When in use, the silver contact receives a strike from a connection leg to form the connection contact of the switch. The instant the switch is connected, the silver contact generates great heat. If the heat is not dispersed smoothly, the contact could melt and result in damage to the switch. The switch could malfunction and its service life will be shortened.

To remedy this problem, a technique has been disclosed in R.O.C. patent publication No. 448454 entitled “Method for fastening silver contacts of conductive blades”. It punches a fastening hole on a conductive blade that is concave on the upper side and convex on the lower side. Extra material for the conductive blade is extruded to form an extended wedging flange. The fastening hole has screw threads formed therein to provide a horizontal frictional force so that the silver contact is less likely to break off. Finally, the top section of the silver wire is formed as a bucking flange through an upper mold, and a lower mold is deployed to ram the wedging flange towards the fastening hole so that the silver wire is filled and wedged securely in the fastening hole. The aforesaid technique can fix the silver contact more securely without breaking loose. The bucking flange increases the heat dissipation area of the silver contact. However, in the design of switches, the interval between the movable contact and the closed circuit contact has to comply with safety regulations (for instance under European safety regulations the interval is 3 mm), the bucking flange will affect the interval between the movable contact and the closed circuit contact, hence the relative positions of the elements in the switch have to be rearranged.

Referring to FIG. 1, to further resolve the problems set forth above, an injection forming approach was proposed to embed the silver contact when the conductive blade is formed by injection. Such a design does not create a bucking flange, and the positions of the elements in the switch do not need to be rearranged. However, embedding by injection forming requires fabricating new molds to suit the different contact sizes of various switches. The manufacturing processes cannot be modularized. As a result, manufacturing costs are increased. Moreover, such an approach does not increase the heat dissipation area between silver contact and conductive blade.

### SUMMARY OF THE INVENTION

The primary object of the invention is to solve the aforesaid problems. The invention provides a structure to increase the contact area between the silver contact and the conductive blade. The conductive blade has a fastening section which has a non-circular and irregular horizontal cross section. In addition, the conductive blade has fixing zones that connect to each other and a bucking end formed with a chamfered angle. The non-circular and irregular horizontal cross section of the fastening section can increase the horizontal frictional force. The bucking end provides a retaining force when the silver contact is struck by the connection leg. Both features mentioned above help to fasten the silver contact more securely without loosening. Moreover, the contact area of the silver contact increases, which also increases the heat conduction area and provides improved heat dissipation.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a cross section of a conventional silver contact.

FIG. 2 is a perspective view of a first embodiment of the conductive blade of the present invention.

FIG. 3 is a perspective view of a first embodiment of a first upper mold of the invention.

FIGS. 4A, 4B and 4C are schematic views of the fabrication process of the first embodiment of the invention.

FIG. 5 is a perspective view of a second embodiment of the conductive blade of the present invention.

FIG. 6 is a top view of the second embodiment of the conductive blade of the present invention.

FIGS. 7A through 7F are schematic views of the fabrication process of the second embodiment of the invention.

FIG. 8 is a cross section of a third embodiment of the present invention.

FIG. 9 is a cross section of a fourth embodiment of the present invention.

FIG. 10 is a cross section of a fifth embodiment of the present invention.

FIG. 11 is a cross section of a sixth embodiment of the present invention.

FIG. 12 is a cross section of a seventh embodiment of the present invention.

FIG. 13 is a cross section of an eighth embodiment of the present invention.

FIG. 14 is a block diagram of the fabricating process for the first embodiment of the invention.

FIG. 15 is a block diagram of the fabricating process for the second embodiment through to the eighth embodiment of the invention.

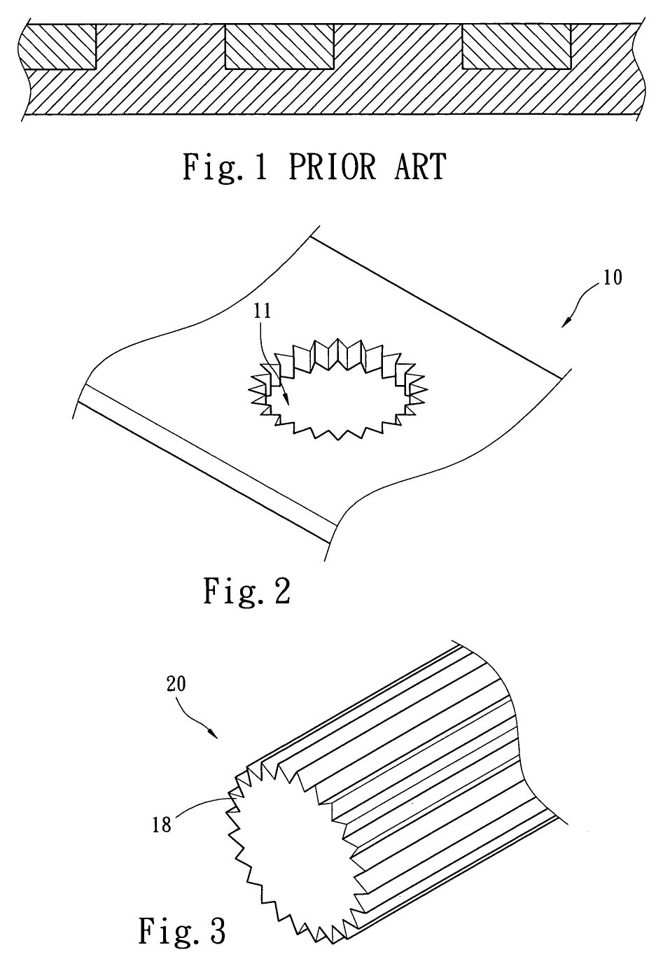

### DETAILED DESCRIPTION OF THE PREFERRED EMBODIMENTS

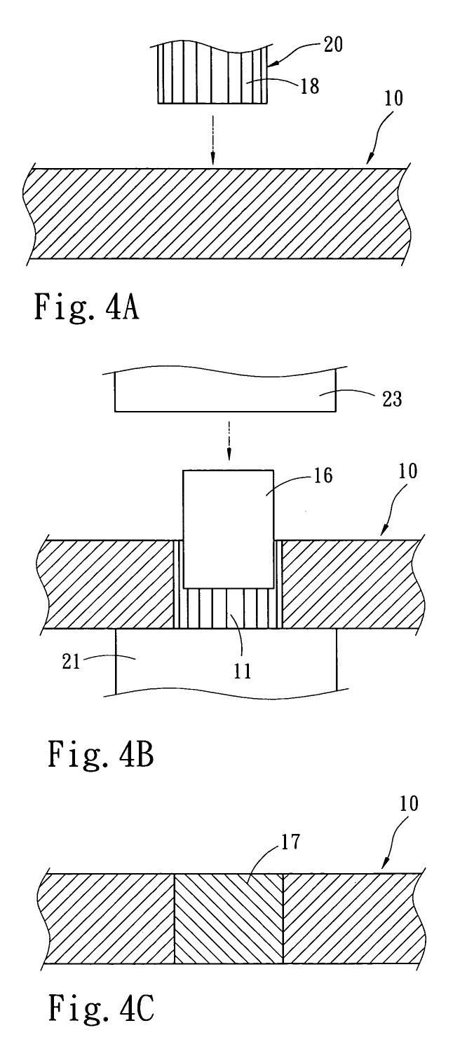

Please refer to FIGS. 2, 3, 4-A, 4-B, 4-C and 14 for a first embodiment of the invention. On a conductive blade 10, there is a fastening section 11 corresponding to the location of a silver contact 17. The fastening section 11 has a non-circular horizontal cross section. Fabrication of the first embodiment includes the following steps in the order of A: stamping a blank, and B: planting a silver wire.

Step A: stamping a blank. First, form the non-circular and irregular fastening section 11 on the conductive blade 10 by stamping through a first upper mold 20. The fastening section 11 has a size about the width of the bucking flange disclosed in R.O.C. patent publication No. 448454 “Method for fastening silver contacts of conductive blades”. In this embodiment, a striking surface is added to the silver contact 17 so that the conductive properties are improved without increasing the amount of silver consumed. The first upper mold 20 has extension angle 18, which is formed in a saw shape. Thus after the conductive blade 10 has been stamped by the first upper mold 20, the contact area between the fastening section 11 and the silver contact 17 increases to improve heat dissipation. Moreover, when the silver contact 17 is wedged in the fastening section 11, the fastening section 11 provides a horizontal frictional force to prevent the silver contact 17 from moving horizontally.

Step B: planting a silver wire. Place the conductive blade 10 on a first lower mold 21; place a silver wire 16 in the fastening section 11; press and fill the silver wire 16 in the fastening section 11 through a third upper mold 23 to form the silver contact 17.

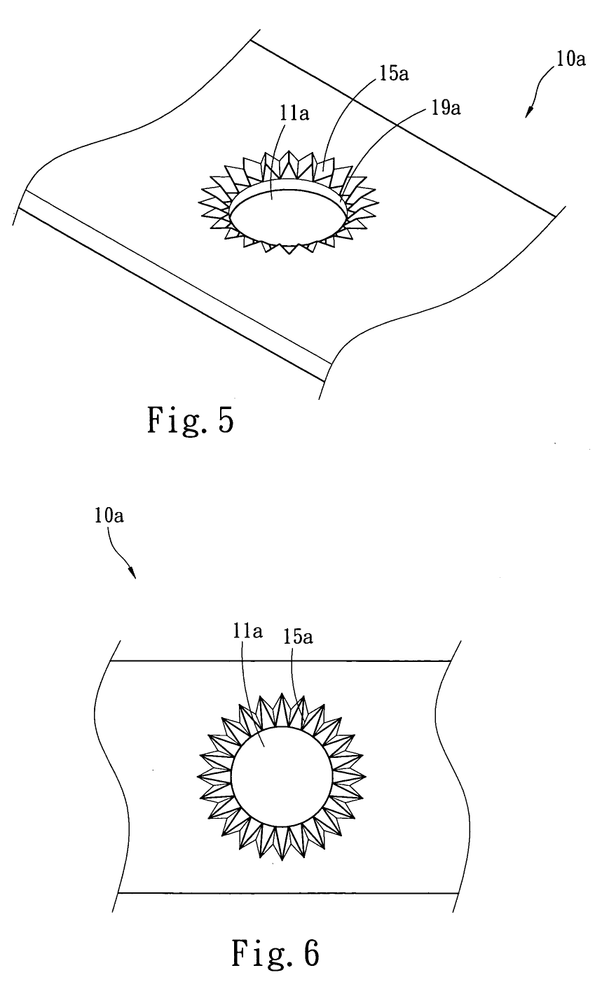

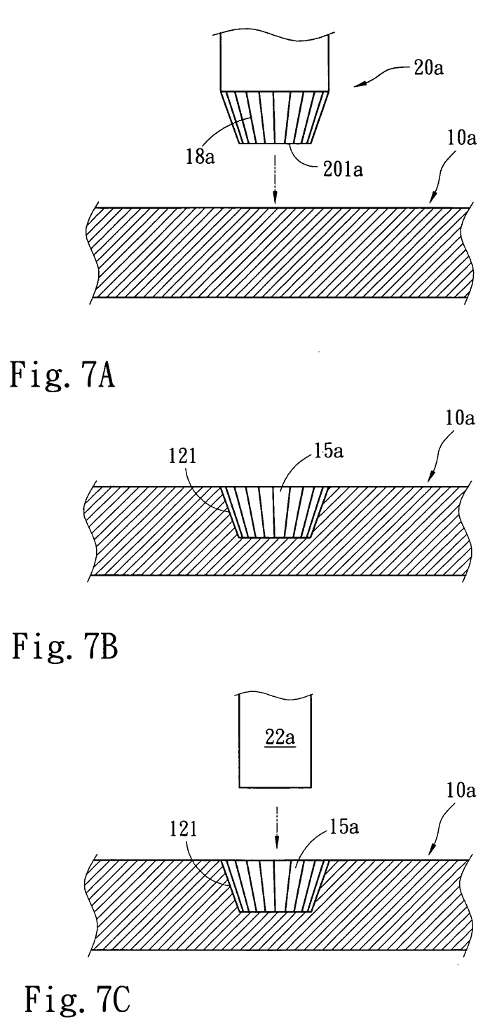

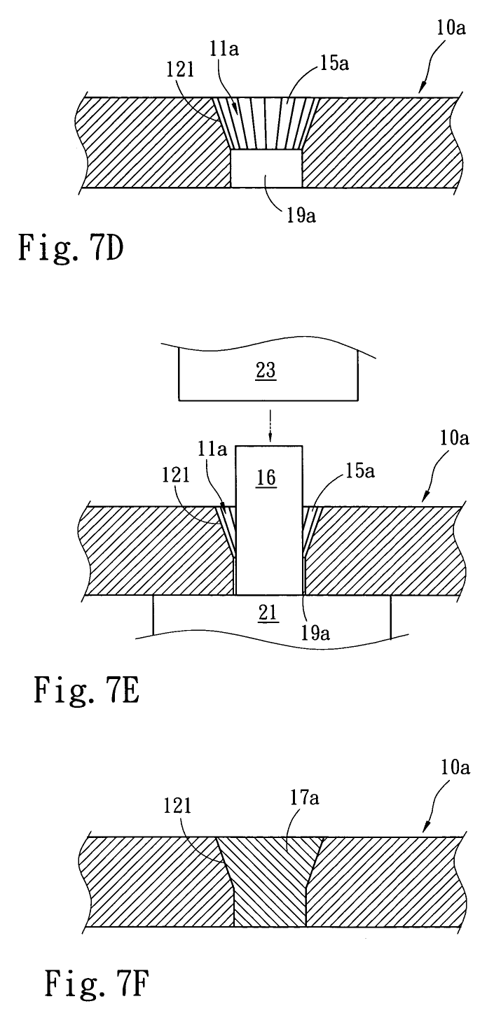

Refer to FIGS. 5, 6, 7-A through 7F and 15 for a second embodiment of the silver contact 17a. The fastening section 11a formed on the conductive blade 10a has a first fixing zone 15a and a second fixing zone 19a that connect each other. The area adjacent to the juncture of the first and the second fixing zones 15a and 19a forms a bucking end 121 with a chamfered angle. The process for fabricating the conductive blade 10a includes the following steps in the order of C: stamping a blank; D: stamping the blank for a second time; and E: planting a silver wire.

Step C: stamping a blank through a first upper mold 20a on the conductive blade 10a to form a first fixing zone 15a. The first upper mold 20a has a punch end 201a which has an extended angle 18a. In this embodiment, the extended angle 18a is tapered at the lower end with the outer side formed in a saw shape.

Step D: stamping the blank for a second time. Form a second fixing zone 19d on the conductive blade 10a that is smaller than the first fixing zones 15a through a second upper mold 22 smaller than the first upper mold 20a. The second upper mold 22 is a cylinder.

Step E: planting a silver wire. Place the conductive blade 10a on a first lower mold 21; place a silver wire 16 in the fastening section 11a which consists of the first fixing zone 15a and the second fixing zone 19a; press and fill the silver wire 16 in the fastening section 11a through a third upper mold 23 to complete the fabrication of the silver contact 17a. The first fixing zone 15a has one end forming a bucking end 121 with a chamfered angle on the peripheral side.

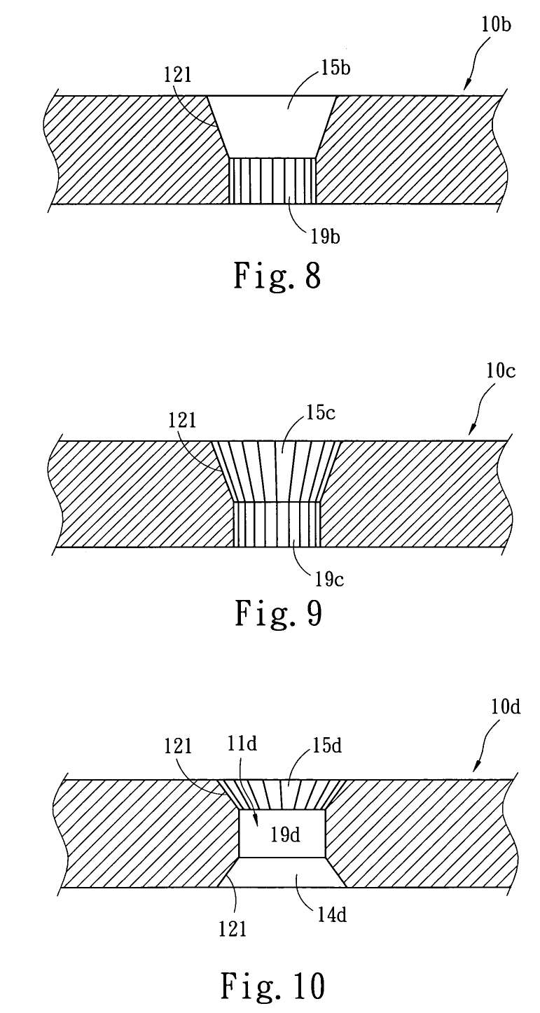

Refer to FIGS. 8 and 9 for the conductive blades 10b and 10c of the third and fourth embodiments. In the third embodiment, the first fixing zone 15b is a conical trough with a tapered lower end, and the second fixing zone 19b is a circular trough with the inner side formed in a saw shape. In the fourth embodiment, the first and second fixing zones 15c and 19c are all formed in a saw shape, and the first fixing zone 15c is a conical trough with a tapered lower end. The fabrication process for the silver contact (not shown in the drawings) is substantially same as the one previously discussed, namely including A: stamping a blank; B: stamping the blank for a second time; and C: planting a silver wire to form the silver contact (not shown in the drawings).

Refer to FIGS. 10 through 13 for a fifth through eighth embodiment of the conductive blades 10d, 10e, 10f and 10g of the invention. The conductive blades 10d, 10e, 10f and 10g have respectively, a first, second and third fixing zone 15d, 19d and 14d. The fabrication process for the fifth embodiment includes C: stamping a blank; D: stamping the blank for a second time; and E: planting a silver wire.

Step C: stamping the blank. Form a first fixing zone 15d and a third fixing zone 14d on an upper end and a lower end of the conductive blade 10d that constitute a conical trough with a tapered end towards the horizontal center of the conductive blade.

Step D: stamping the blank for a second time. Form a second fixing zone 19d on the conductive blade 10d that is smaller than the first fixing zone 15d and the third fixing zone 14d. In the fifth embodiment, only the first fixing zone 15d has the peripheral side formed in a saw shape.

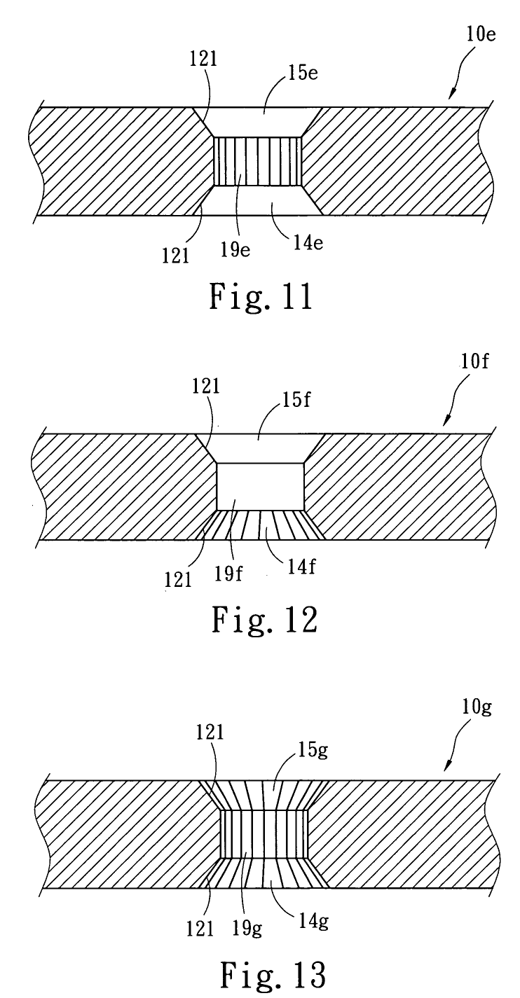

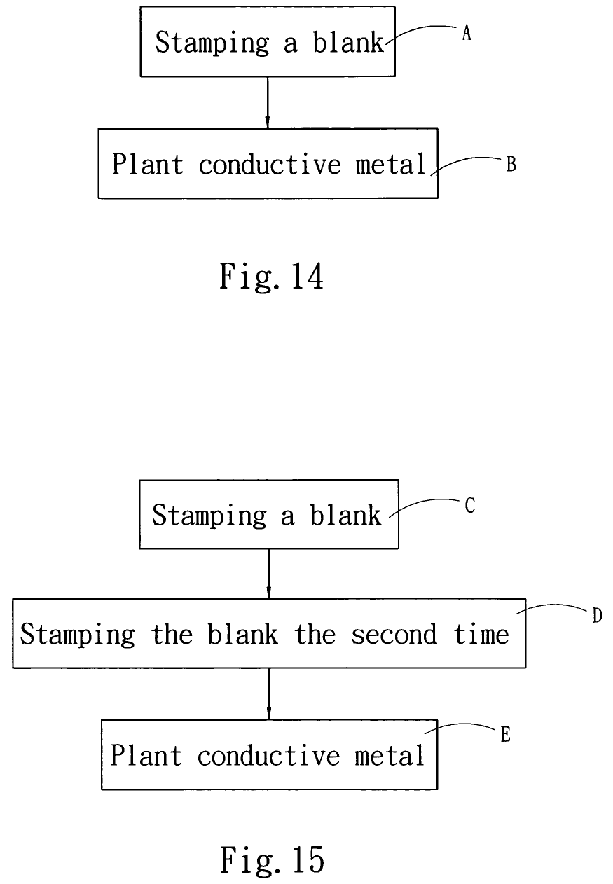

Step E: planting a silver wire (not shown in the drawings). Place the silver wire in the fastening section 11d that consists of the first, second and third fixing zones 15d, 19d and 14d. Press and fill the silver wire (not shown in the drawings) into the fastening section 11d. Fabrication processes of the sixth embodiment (FIG. 11) and the seventh embodiment (FIG. 12) are substantially similar to the one previously discussed. However, in the sixth embodiment, only the third fixing zones 14e (FIG. 11) is formed in a saw shape, while in the seventh embodiment only the second fixing zone 19f (FIG. 12) is formed in a saw shape. In the eighth embodiment, the first, second and third fixing zones 15g, 19g and 14g are all formed in a saw shape.

While the preferred embodiments of the invention have been set forth for the purpose of disclosure, modifications to the disclosed embodiments of the invention as well as other embodiments thereof may occur to those skilled in the art. Accordingly, the appended claims are intended to cover all embodiments that do not depart from the spirit and scope of the invention.

1. A silver contact structure for conductive blades comprising a conductive blade which has a fastening section for holding a silver contact;
wherein the fastening section has a non-circular saw shape horizontal cross section for increasing contact area between said fastening section and said silver contact.

2. The silver contact structure of claim 1, wherein the silver contact structure is formed by a fabrication method which comprises steps of:
A. stamping a blank by stamping the conductive blade with an upper die which has an extended angle on the perimeter surface to form the non-circular fastening section; and
B. planting a silver wire by placing the conductive blade on a first lower die, placing the silver wire in the fastening section, and pressing and filling the silver wire in the fastening section through a second upper die.

3. The silver contact structure of claim 1, wherein the fastening section includes at least two fixing zones that connect each other, and an end adjacent to the juncture of the fixing zones that has a chamfered angle.

4. The silver contact structure of claim 3, wherein the fastening section includes a first fixing zone and a second fixing zone connecting each other, the silver contact structure being formed by a fabrication method which comprises steps of:
A. stamping a blank by stamping the conductive blade with an upper die to form the first fixing zone;
B. stamping the blank for a second time by stamping the conductive blade with a second upper die which is smaller than the first upper die to form the second fixing zone smaller than the first fixing zone; and
C. planting a silver wire by placing the conductive blade on a first lower die, placing the silver wire in the fastening section formed by the first fixing zone and the second fixing zone, and pressing and filling the silver wire in the fastening section through a third upper die.

5. The silver contact structure of claim 4, wherein the first upper die has an extended angle on the perimeter surface, and the first fixing zone has a non-circular horizontal cross section.

6. The silver contact structure of claim 4, wherein the second upper die has an extended angle on the perimeter surface, and the second fixing zone has a non-circular horizontal cross section.

7. The silver contact structure of claim 4, wherein the first upper die and the second upper die have respectively an extended angle on the perimeter surface, and the first fixing zone and the second fixing zone have a non-circular horizontal cross section.

8. The silver contact structure of claim 3, wherein the fastening section includes a first fixing zone, a second fixing zone and a third fixing zone on a vertical surface thereof corresponding to the conductive blade, the silver contact structure being formed by a fabrication method which comprises steps of:
A. stamping a blank by stamping the conductive blade with a first upper die and a second lower die on an upper end and a lower end thereof to form a first fixing zone and a third fixing zone on the conductive blade;
B. stamping the blank for a second time by stamping the conductive blade with a second upper die which is smaller than the first upper die and a third upper die to form a second fixing zone smaller than the first and third fixing zones; and
C. planting a silver wire by placing the conductive blade on a first lower die, placing the silver wire in the fastening section formed by the first fixing zone, the second fixing zone and the third fixing zone, and pressing and filling the silver wire in the fastening section through a third upper die.

9. The silver contact structure of claim 8, wherein the first upper die has an extended angle on the perimeter surface, and the first fixing zone has a non-circular horizontal cross section.

10. The silver contact structure of claim 8, wherein the second upper die has an extended angle on the perimeter surface, and the second fixing zone has a non-circular horizontal cross section.

11. The silver contact structure of claim 8, wherein the second lower die has an extended angle on the perimeter surfaces, and the third fixing zone has a non-circular horizontal cross section.

12. The silver contact structure of claim 8, wherein the first upper die, the second upper die and the first lower die have respectively an extended angle on the perimeter surfaces, and the first fixing zone, the second fixing zone and the third fixing zone have non-circular horizontal cross sections.
